(19) United States
(12) Patent Application Publication
(10) Pub. No.: US 2012/0311216 A1
(43) Pub. Date: Dec. 6, 2012

(54) Multifunction Computer Dock

(75) Inventor: Johnny Chen, Santa Ana, CA (US)

(73) Assignee: I/O Interconnect, Ltd.

(21) Appl. No.: 13/223,241

(22) Filed: Aug. 31, 2011

Related U.S. Application Data
(60) Provisional application No. 61/491,316, filed on May 30, 2011.

(51) Int. Cl. G06F 13/14

(52) U.S. Cl. 710/303

(57) ABSTRACT

A multifunction dock station for portable computer is disclosed. The dock includes a connection port, a switch, a controller, a network-attached storage (NAS) and an I/O bus for connecting input/output or storage devices. The connection port is used for connecting a computer and electrically connects to the controller and switch. The switch is controlled by the controller and has a group of common pins connecting the connection port and two groups of switching pins separately connecting the NAS and I/O bus. The switch connects the NAS and connection port when the connection port is not connected by a computer. The switch connects the I/O bus and connection port when the connection port is connected by a computer.

### CROSS-REFERENCE TO RELATED APPLICATIONS

This application claims the benefit of U.S. provisional application No. 61/491,316, filed on May 30, 2011.

### BACKGROUND OF THE INVENTION

1. Technical Field

The invention relates to dock stations for portable computers, particularly to dock stations with multifunction.

2. Related Art

Docking systems are very useful for portable computers. Usually, a dock is provided with a plurality of input/output (I/O) ports, a hard disk drive (HDD) and a battery to make a portable computer such as a laptop or tablet computer simulatedly serves as a desktop computer. A dock only works when it has been connected by a portable computer. However, none has attempted to provide another function which can work when the portable computer is disconnected or even taken away from the dock.

On the other hand, with the development of network and the popularity of portable electronic devices, network-attached storages (NASes) become more and more important. The NAS is file-level computer data storage connected to a computer network for providing data access to heterogeneous clients. As of 2010 NAS devices are gaining popularity, as a convenient method of sharing files among multiple computers. NAS is useful for more than just general centralized storage provided to client computers in environments with large amounts of data. NAS can enable simpler and lower cost systems such as load-balancing and fault-tolerant email and web server systems by providing storage services. Thus NAS is very useful for users of portable computers.

### SUMMARY OF THE INVENTION

An object of the invention is to provide a multifunction computer dock which adds a network-attached storage (NAS) besides fundamental docking functions such as I/O ports and/or storage.

To accomplish the above object, the dock of the invention includes a connection port, a switch, a controller, a network-attached storage (NAS), a hard disk drive (HDD) and I/O ports for connecting input/output devices. The connection port is used for connecting a computer and electrically connects to the controller and switch. The switch is controlled by the controller and has a group of common pins connecting the connection port and two groups of switching pins separately connecting the NAS and HDD with I/O ports. The switch connects the path between the NAS and connection port to make the dock serve as a NAS when the connection port is not connected by a computer. The switch connects the path between the HDD with I/O ports and connection port to make the dock serve as a dock when the connection port is connected by a computer.

### BRIEF DESCRIPTION OF THE DRAWING

FIG. 1 is a block diagram of a conventional dock; and

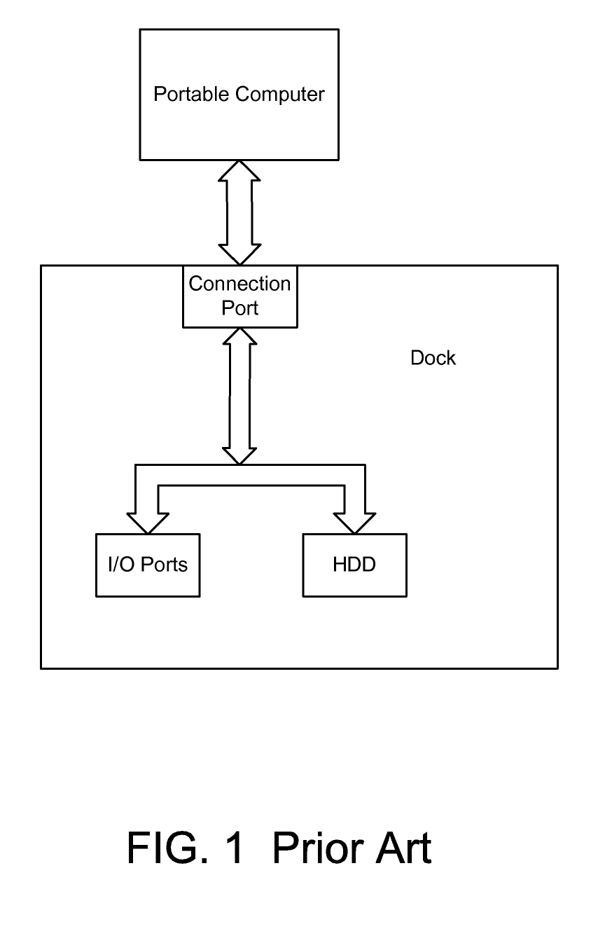

FIG. 2 is a block diagram of the invention.

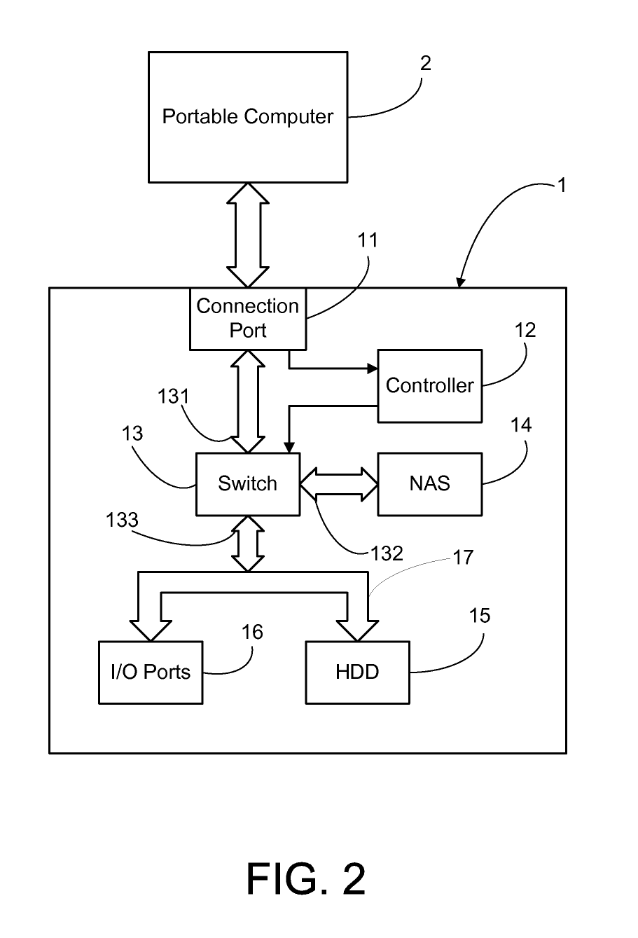

### DESCRIPTION OF THE INVENTION

Please refer to the figure. The dock 1 of the invention is used for a portable computer 2 such as a laptop or tablet computer to provide expanded functions. The dock 1 includes a connection port 11, a switch 13, a controller 12, a network-attached storage (NAS) 14 and input/output (I/O) bus 17. The I/O bus 17 may be used to connect a hard disk drive (HDD) 15 and a plurality of I/O ports 16.

The connection port 11 is used for mechanically and electrically connecting the portable computer 2 and electrically connects to the controller 12 and switch 13. The switch 13 is of an electronic type and electrically controlled by the controller 12 and has a group of common pins 131 connecting the connection port 11 and two groups of switching pins 132, 133 respectively connecting the NAS 14 and the I/O bus 17. Hence, the HDD 15 and I/O ports 16 are connected to the one group of switching pins 133. All of the data and/or power passing through the connection port 11 are electrically connected to the group of common pins 131.

The I/O ports 16 may be used for connecting input/output devices such as mouse, keyboard, microphone, speaker and display. The HDD 15 is a storage device and can also be in any other form such as solid state disk (SSD) or RAID.

The switch 13 can make an electric connection between the group of common pins 131 and either of the two groups of switching pins 132 and 133 under control of the controller 12. The controller 12 is capable of sensing whether the connection port 11 is connected by the portable computer 2 or not. For example, the connection port 11 may be provided with a micro switch for electrically connecting to the controller 12. Thus, the controller 12 can sense the connection of the portable computer 2 to control the switch 13.

When the connection port 11 is not connected by the portable computer 2, the controller 12 controls the switch 13 to connect the electric path between the NAS 14 and the connection port 11 to make the dock 1 function as a NAS which works alone. In the meantime, the I/O bus 17, HDD 15 and I/O ports 16 are disconnected with the connection port 11 to idle. When the connection port 11 is connected by the portable computer 2, the controller 12 controls the switch 13 to connect the electric path between the connection port 11 and the I/O bus 17 to make the dock 1 function as a dock station. In the meantime, the NAS 14 is disconnected with the connection port 11 to idle. In other words, the dock 1 of the invention can be automatically switched to serve as a NAS or a fundamental dock.

It will be appreciated by persons skilled in the art that the above embodiment has been described by way of example only and not in any limitative sense, and that various alterations and modifications are possible without departure from the scope of the invention as defined by the appended claims. It will be appreciated by persons skilled in the art that the above embodiment has been described by way of example only and not in any limitative sense, and that various alterations and modifications are possible without departure from the scope of the invention as defined by the appended claims.

What is claimed is:

1. A multifunction computer dock comprising:
a controller,
a switch, electrically connected to and controlled by the controller, and having a group of common pins and two groups of switching pins;
a connection port for connecting an external computer, electrically connected to the controller and the group of common pins of the switch;
a network-attached storage (NAS), electrically connecting the one group of switching pins;
an input/output (I/O) bus, electrically connecting the other one group of switching pins;
wherein the controller is capable of sensing whether the connection port is connected by the external computer or not, the controller controls the switch to connect the NAS and the connection port when the connection port is not connected by the external computer, and the controller controls the switch to connect the connection port and the I/O bus when the connection port is connected by the external computer.

2. The multifunction computer dock of claim 1, wherein the I/O bus is further connected to a storage device.

3. The multifunction computer dock of claim 2, wherein the storage device is a hard disk drive.

4. The multifunction computer dock of claim 1, wherein the I/O bus is further connected to an input/output (I/O) port.
